(19) United States
(12) Patent Application Publication
(10) Pub. No.: US 2016/0293097 A1
(43) Pub. Date: Oct. 6, 2016

(54) DISPLAY DEVICE

(71) Applicant: FUNAI ELECTRIC CO., LTD., Osaka (JP)

(72) Inventors: Hirotaka MOMOEDA, Osaka (JP); Naofumi MORIYAMA, Osaka (JP)

(73) Assignee: FUNAI ELECTRIC CO., LTD.

(21) Appl. No.: 15/085,046

(22) Filed: Mar. 30, 2016

(30) Foreign Application Priority Data
Apr. 2, 2015 (JP) 2015-076257

(51) Int. Cl. G09G 3/20

(52) U.S. Cl. CPC G09G 3/2096; G09G 3/2003; G09G 2320/0626

(57) ABSTRACT

A display device includes a display, a light source, a power supply, and a controller. The light source emits light from a rear face side of the display. The power supply supplies power to the display. The controller controls the light source based on a value of voltage and/or current supplied to the display.

### CROSS-REFERENCE TO RELATED APPLICATIONS

This application claims priority to Japanese Patent Application No. 2015-076257 filed on Apr. 2, 2015. The entire disclosure of Japanese Patent Application No. 2015-076257 is hereby incorporated herein by reference.

### BACKGROUND

1. Field of the Invention

The present invention generally relates to a display device. More specifically, the present invention relates to a display device that uses a backlight to display image.

2. Background Information

Display devices that use a backlight to display video, such as a liquid crystal display, include a device whose function is to adjust the luminance of the backlight. The luminance of a backlight is adjusted using a gradation value of a video signal (see Japanese Laid-Open Patent Application Publication No. H10-148807 (Patent Literature 1), for example). With a display device such as this, if there are many pixels with a large gradation value, control is performed to increase the brightness of the backlight, and if there are many pixels with a small gradation value, the brightness of the backlight is lowered.

### SUMMARY

However, when a backlight is controlled using the gradation value of a video signal, the video signal has to be decoded, etc., and this increases the amount of computation performed by the controller. That is, with conventional backlight control, a problem is the greater load on the controller. Also, when a backlight is controlled using the gradation value of a video signal, variance of the characteristics in the manufacture of the circuit are not taken into account, so a problem is that accuracy is not good enough.

One aspect of the present application is to provide a display device with which there is less load on the controller, and a backlight can be controlled more accurately.

In view of the state of the known technology and in accordance with a first aspect of the present disclosure, a display device comprises a display, a light source that emits light from a rear face side of the display, a power supply that supplies power to the display, and a controller that controls the light source based on a value of voltage and/or current supplied to the display.

### BRIEF DESCRIPTION OF THE DRAWINGS

Referring now to the attached drawings which form a part of this original disclosure:

FIG. 1 is an exploded perspective view of a liquid crystal display in accordance with an embodiment;

FIG. 2 is a block diagram of the configuration of a controller and an open cell illustrated in FIG. 1;

FIG. 3 is a block diagram of the configuration of a power supply board in accordance with the embodiment;

FIG. 4 is a diagram of the configuration of a current measurement circuit in accordance with the embodiment;

FIG. 5 is a diagram of the configuration of a current measurement circuit in accordance with a first modification example;

FIG. 6 is a diagram of the configuration of a current measurement circuit in accordance with a second modification example;

FIGS. 7A, 7B, and 7C are graphs of the relation between the luminance of the image, the measured amount of current, the PWM signal, and the backlight luminance in accordance with the embodiment;

FIGS. 8A, 8B, 8C, and 8D are graphs of the relation between the luminance of the image, the measured amount of current, the PWM signal, the backlight luminance, and the power consumption in accordance with the embodiment;

FIG. 9 is a graph of the drive current while the backlight is illuminated, versus an adjustment value; and

FIG. 10 is a graph of the backlight illumination duty ratio versus an adjustment value.

### DETAILED DESCRIPTION OF EMBODIMENTS

A selected embodiment will now be described in detail through reference to the drawings. In these drawings, the dimensions, dimensional ratios, and so forth may not necessarily be to scale. The embodiment described below is nothing more than a comprehensive and specific example. The numerical values, shapes, materials, constituent elements, layout positions and connection modes of the constituent elements, and so forth given in the following embodiment are provided for illustration only and not for the purpose of limiting the invention as defined by the appended claims and their equivalents. Also, of the constituent elements in the following embodiment, those not mentioned in an independent claim are described as optional constituent elements.

### Embodiment

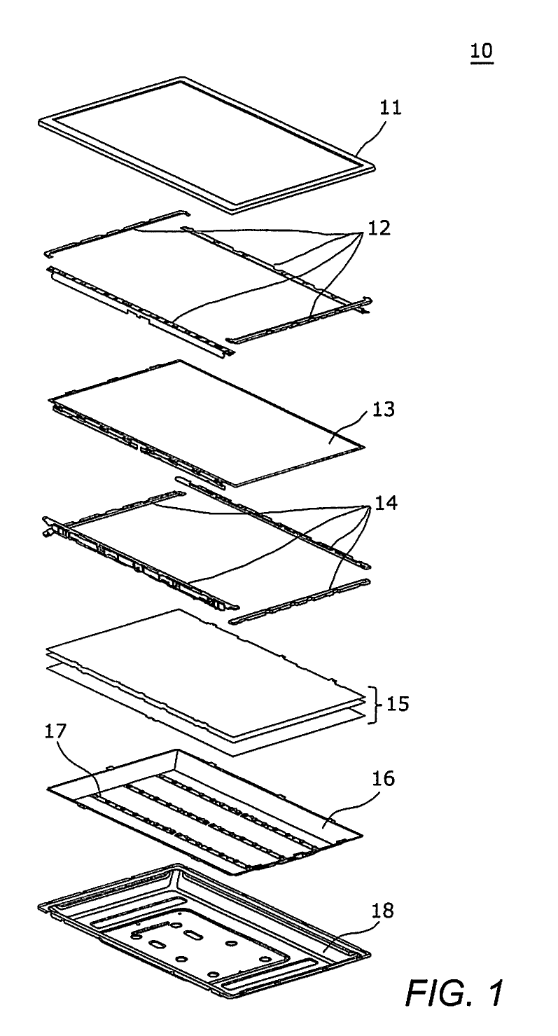

A liquid crystal display in an embodiment will be described through reference to FIGS. 1 to 4.

The liquid crystal display in this embodiment is an example of a display device that displays video using a video signal included in a broadcast wave, or a video signal inputted from a BD (Blu-ray® Disc) or other such external device.

The liquid crystal display in this embodiment is configured so that backlight control is performed according to the brightness of the image being displayed. The backlight control will be described later.

1-1. Liquid Crystal Display

The configuration of the liquid crystal display 10 in this embodiment will be described through reference to FIGS. 1 to 3.

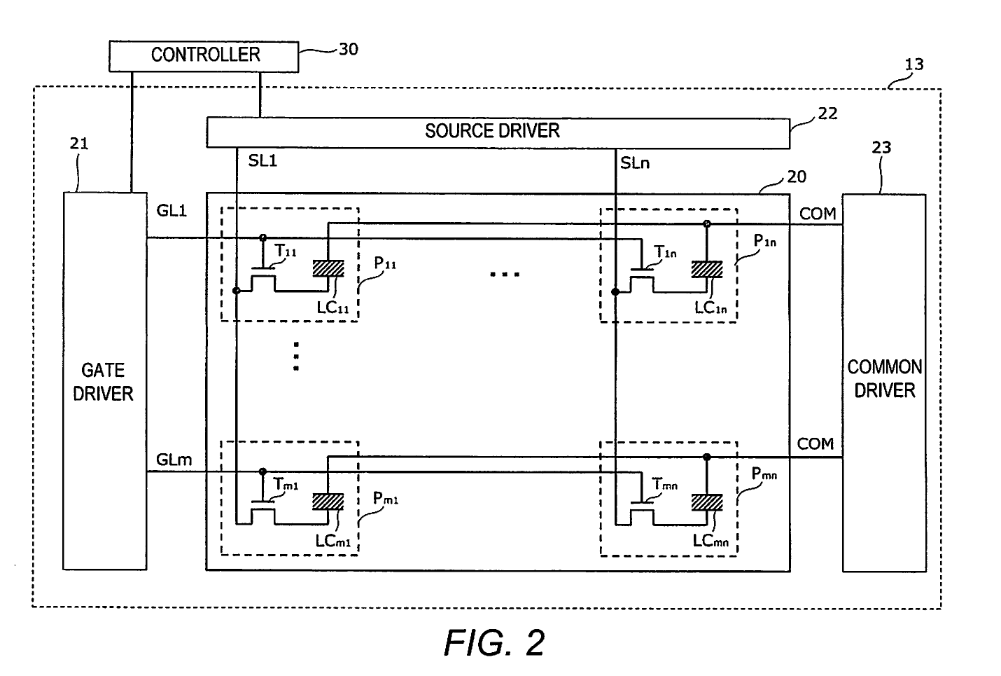

FIG. 1 is an exploded perspective view of the liquid crystal display 10. FIG. 2 is a block diagram of the configuration of a controller 30 and an open cell 13 illustrated in FIG. 1.

As shown in FIG. 1, the liquid crystal display 10 includes a front cabinet 11, a bezel 12, the open cell 13 (display), a cell guide 14, an optical member 15, a reflective member 16, a backlight 17, and a rear frame 18. The liquid crystal display 10 further includes a power supply board 40, a current measurement circuit 31A, and the controller 30.

The front cabinet 11 is a member that makes up half of the front side of the housing of the liquid crystal display 10. This housing is made up of the front cabinet 11 and a rear cabinet, which is not depicted in FIG. 1. The front cabinet 11 is made from plastic in this embodiment.

The bezel 12 is a member that supports the open cell 13 from the front side of the liquid crystal display 10.

The open cell 13 includes a liquid crystal panel 20, a COF (chip on film, or chip on flexible), and a PCB (printed circuit board). The COF is a flexible cable equipped with an IC (integrated circuit) that drives the liquid crystal panel 20. The open cell 13 will be described in detail below.

The cell guide 14 is a member for preventing the open cell 13 from becoming misaligned.

The optical member 15 is a member for adjusting the luminance, etc., of light from the light source, and is constituted by a plurality of sheets including an optical sheet and a diffusion sheet.

The reflective member 16 is a sheet-form member that reflects light from the backlight 17.

The backlight 17 is an example of the light source of the liquid crystal display 10, and is constituted by a plurality of LED bars. The LED bars includes a plurality of LEDs and an LED board on which the LED bars are mounted. The backlight 17 is configured so that its luminance increases in proportion to the duty ratio of a PWM signal, which is an example of a control signal for controlling the backlight 17.

The rear frame 18 is a member to which the backlight 17 is attached, and is disposed on the rear face of the backlight 17.

The power supply board 40, the current measurement circuit 31A, and the controller 30 are circuits used to drive the liquid crystal panel 20. The power supply board 40, the current measurement circuit 31A, and the controller 30 will be described in detail below.

1-1-1. Open Cell

As shown in FIGS. 1 and 2, the open cell 13 includes the liquid crystal panel 20, a gate driver 21, a source driver 22, and a common driver 23.

The liquid crystal panel 20 is an example of a display panel, and includes sub-pixels P₁₁ to Pₘₙ (m is the number of rows, and n is the number of columns) laid out in a matrix, gate lines GL1 to GLm, data lines or source lines SL1 to SLn, and common wiring COM. Sub-pixels Pᵢⱼ (i=1 to m, j=1 to n) includes liquid crystals LCij and switching elements Tij. The liquid crystals LCij are configured such that a liquid crystal layer is formed between a common electrode and a pixel electrode, with the common electrodes connected to the common wiring COM, and the pixel electrodes to the drain terminals of the switching elements Tij. The switching elements Tij are TFT (thin film transistors), for example, with the gate terminals connected to the gate line GLi, the drain terminals to the pixel electrodes of the liquid crystals LCij, and the source terminals to a source line SLj. The sub-pixels P₁₁ to Pₘₙ are pixels corresponding to red, green, or blue, and one pixel is made up of three sub-pixels. These sub-pixels are examples of display pixels.

In this embodiment, a case will be described in which the sub-pixels P₁₁ to Pₘₙ are liquid crystals that are normally black, with which the transmittance is lowest when no voltage is being applied.

The gate driver 21, the source driver 22, and the common driver 23 are each formed of a COF group that includes a plurality of COFs. The output terminal of a COF is connected to the liquid crystal panel 20, and the input terminal to the output terminal of the PCB.

The gate driver 21 is connected via the gate lines GL1 to GLm to the gate terminals of switching elements T₁₁ to Tₘₙ that are part of the sub-pixels P₁₁ to Pₘₙ. With the liquid crystal display 10, write processing is executed in row units. The gate driver 21 applies voltage to the gate line GLi of the selected pixel row, to switch on the switching elements Tᵢ₁ to Tᵢₙ that constitute the sub-pixels Pᵢ₁ to Pᵢₙ connected to said gate line GLi.

The source driver 22 is an example of a drive circuit or driver that uses a second DC power PS2 supplied from a second power supply 42 to produce a plurality of data signals corresponding to the gradation values of the sub-pixels Pᵢ₁ to Pᵢₙ, and supplies the plurality of data signals to the sub-pixels Pᵢ₁ to Pᵢₙ. Data signals are drive signals. The source driver 22 is connected via the source lines SL1 to SLn and the switching elements T₁₁ to Tₘₙ to the pixel electrodes of the liquid crystals LC₁₁ to LCₘₙ. The source driver 22 applies data signals having a voltage value corresponding to the pixel values of the selected sub-pixels Pᵢ₁ to Pᵢₙ, to the source lines SL1 to SLn.

The common driver 23 is connected via the common wiring COM to the common electrodes of the liquid crystals LC₁₁ to LCₘₙ. The common driver 23 applies a common voltage VCOM to the common wiring COM.

1-1-2. Power Supply Board

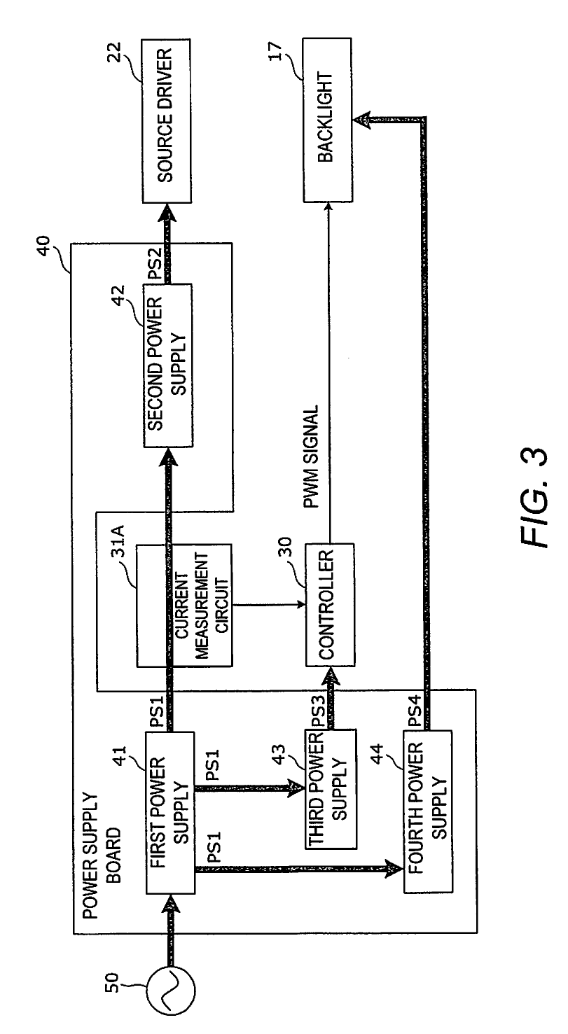

FIG. 3 is a block diagram of an example of the configuration of the power supply board 40 in this embodiment.

The power supply board 40 is a board on which is mounted a circuit for supplying power to the various circuits constituting the liquid crystal display 10. This circuit includes a power supply that supplies power to the liquid crystal panel 20. As shown in FIG. 3, a first power supply 41, a second power supply 42, a third power supply 43, and a fourth power supply 44 are disposed on the power supply board 40. The first power supply 41 and the second power supply 42 are included in the above-mentioned power supply.

The power supply board 40 does not need to be a single board. Also, the power supply board 40 may be shared by other boards (such as the board used for control). The first to fourth power supplies 41 to 44 formed on the power supply board 40 may be constituted by a single IC, or by a plurality of ICs. Also, the first to fourth power supplies 41 to 44 may be dispersed over a plurality of boards.

The first power supply 41 produces a first DC power PS1 by converting the AC power supplied from an AC power supply 50 into DC power. The first power supply 41 supplies the first DC power PS1 to the second power supply 42, the third power supply 43, and the fourth power supply 44. The first power supply 41 may also supply power having a different voltage or current value to the second power supply 42, the third power supply 43, and the fourth power supply 44.

The second power supply 42 uses the first DC power PS1 supplied from the first power supply 41 to produce the second DC power PS2 for driving the plurality of sub-pixels Pᵢ₁ to Pᵢₙ. The second DC power PS2 is used as a power supply at the source driver 22. More specifically, the second power supply 42 is configured using a booster circuit or a voltage down converter, and produces the second DC power PS2 by converting the voltage value of the first DC power PS1 to the voltage value of the power supply voltage used at the source driver 22. The second power supply 42 outputs the second DC power PS2 to the source driver 22.

The third power supply 43 uses the first DC power PS1 supplied from the first power supply 41 to produce a third DC power PS3 for actuating the controller 30, and supplies this to the controller 30. The third power supply 43 is configured using a booster circuit or a voltage down converter.

The fourth power supply 44 uses the first DC power PS1 supplied from the first power supply 41 to produce a fourth DC power PS4 for lighting the backlight 17, and supplies this to the backlight 17. The fourth power supply 44 is configured using a booster circuit or a voltage down converter.

1-1-3. Current Measurement Circuit

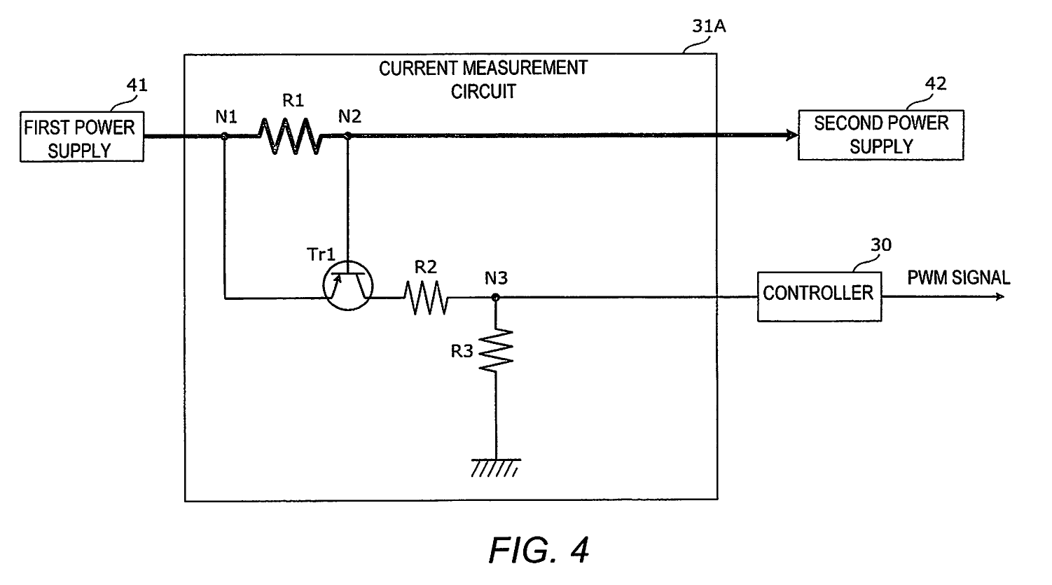

FIG. 4 is a diagram of an example of the configuration of the current measurement circuit 31A in this embodiment.

The current measurement circuit 31A is an example of a measurement component that measures the supply amount or value of power, voltage and/or current supplied by a power supply. The current measurement circuit 31A measures the amount of current flowing to the second power supply 42, and inputs the measurement result to the controller 30. As shown in FIG. 4, the current measurement circuit 31A includes a first resistor element R1, a transistor Tr1, a second resistor element R2, and a third resistor element R3.

The first resistor element R1 is connected between the output terminal of the first power supply 41 and the input terminal of the second power supply 42. The voltage difference between the ends of the first resistor element R1 corresponds to the current amount.

The base end of the transistor Tr1 is connected to one end of the first resistor element R1, and the emitter end is connected to the other end of the first resistor element R1. In FIG. 4, the node connected to one end of the first resistor element R1 is labeled “node N1,” and the node connected to the other end is labeled “node N2.” The base terminal is an example of a control terminal, and the emitter terminal and connector terminal are examples of a first output terminal and second output terminal.

The second resistor element R2 is connected at one end to the connector terminal, and at the other end to a node N3, which is the output node of the current measurement circuit 31A.

The third resistor element R3 is connected at one end to the node N3, and at the other end to ground voltage.

Because the current measurement circuit 31A is thus configured, the voltage value corresponding to the value of the current flowing to the resistor element R1 is inputted to the controller 30.

In this embodiment, a case is described in which the resistor element R1 is connected between the output terminal of the first power supply 41 and the input terminal of the second power supply 42, but the resistor element RI may instead be connected between the output terminal of the second power supply 42 and the input terminal of the source driver 22. In other words, in this embodiment the current measurement circuit 31A measures the supply amount of power of the first DC power PS1 supplied to the second power supply 42, but may instead measure the supply amount of power of the second DC power PS2 outputted from the second power supply 42.

When current flows to the first resistor element R1, it produces a voltage difference corresponding to the amount of current at both ends of the first resistor element R1. If this voltage difference exceeds the threshold voltage of the transistor Tr1, that is, if the voltage difference between base and emitter exceeds the threshold voltage, then current flows between the collector and emitter of the transistor Tr1 in an amount corresponding to the voltage difference between the two ends of the first resistor element R1. Since the current flowing between the collector and emitter of the transistor Tr1 flows unchanged to the second resistor element R2, the voltage value at the other end of the second resistor element R2 corresponds to the current flowing between the collector and emitter of the transistor Tr1. That is, the voltage value of the node N3 connected to the other end of the second resistor element R2 corresponds to the amount of current flowing to the first resistor element R1. The voltage value of the node N3 is inputted to the controller 30.

In this embodiment, a case is described in which the measurement component is the current measurement circuit 31A that measures the current amount, but a circuit that measures the voltage value (e.g., supply amount of voltage) (a circuit that measures the voltage value directly, or measures the amount of fluctuation in the voltage value) may be provided alternatively or additionally as the measurement component. In this case, the circuit measures the voltage value supplied to the liquid crystal panel 20. Also, a circuit that measures the power supplied to the liquid crystal panel 20 can be used alternatively or additionally as the measurement component.

1-1-4. Controller

The controller 30 controls the liquid crystal panel 20. Control of the liquid crystal panel 20 includes processing to write to the sub-pixels P₁₁ to Pₘₙ, and backlight control.

The controller 30 preferably includes a microcomputer or processor with a control program that controls the liquid crystal panel 20 as discussed below. The controller 30 can also include other conventional components such as an input interface circuit, an output interface circuit, and storage devices such as a ROM (Read Only Memory) device and a RAM (Random Access Memory) device. The microcomputer of the controller 30 is programmed to control the liquid crystal panel 20. The memory devices store processing results and control programs such as ones for controlling the liquid crystal panel 20 that are run by the processor circuit. The controller 30 is operatively coupled to the various components of the liquid crystal display 10 in a conventional manner. The internal RAM of the controller 30 stores statuses of operational flags and various control data. The internal ROM of the controller 30 stores the programs for various operations. The controller 30 is capable of selectively controlling any of the components of the liquid crystal display 10 in accordance with the control program. It will be apparent to those skilled in the art from this disclosure that the precise structure and algorithms for the controller 30 can be any combination of hardware and software that will carry out the functions of the present invention.

1-2. Operation of Liquid Crystal Display

The operation of the liquid crystal display 10, and more particularly the operation related to write processing and backlight control, will now be described.

1-2-1. Write Processing

In write processing, the controller 30 analyzes a video signal and acquires gradation values corresponding to the various sub-pixels P₁₁ to Pₘₙ. The controller 30 also outputs a signal indicating said gradation values to the source driver 22.

More specifically, with the liquid crystal display 10, write processing is performed to vary the transmittance of the sub-pixels P₁₁ to Pₘₙ in row units. The transmittance of each cell is determined according to the voltage value applied to the liquid crystals. The source driver 22 produces data signals having voltage according to the gradation values of the corresponding video signal based on the power supplied from the second power supply 42 for the plurality of sub-pixels Pₖ₁ to Pₖₙ included in the selected row k (k=1 to m), respectively. The source driver 22 applies the respective data signals thus produced to the source lines SL1 to SLn connected to the corresponding sub-pixels Pₖ₁ to Pₖₙ.

Accordingly, the amount of current flowing to the second power supply 42 corresponds to the sum total for the gradation values of the video signal at the sub-pixels Pₖ₁ to Pₖₙ.

The voltage value of the output signal of the current measurement circuit 31A corresponds to the amount of current flowing to the second power supply 42.

1-2-2. Backlight Control

In backlight control, the controller 30 adjusts the luminance of the backlight 17 according to the brightness of the image displayed on the liquid crystal display 10. The brightness of an image is, for example, the sum total of the gradation values for the image, the average of the gradation values of the image, etc. More specifically, the controller 30 produces a PWM signal having a duty ratio corresponding to the amount of current measured by the current measurement circuit 31A. The PWM signal is an example of a control signal for controlling the backlight 17.

In this embodiment, as discussed above, the voltage value of the signal outputted from the current measurement circuit 31A corresponds to the measured amount of current. Therefore, the controller 30 produces a PWM signal having a duty ratio corresponding to the inputted voltage value.

The voltage value of the signal outputted from the current measurement circuit 31A also corresponds to the current value of the power supplied to one row of cells. That is, the PWM signal has a duty ratio corresponding to the sum total of gradation values for the video signal in one row of cells.

The backlight control here includes first backlight control in which the brighter is the image being displayed, that is, the greater is the total of the gradation values included in the video signal, the higher is the luminance to which the backlight 17 is set, and second backlight control in which the luminance of the backlight 17 is set so as to lower the overall power consumption of the liquid crystal display 10. The controller 30 executes the second backlight control when the user selects an energy saving mode, and executes the first backlight control when the user does not select the energy saving mode. The controller 30 may be configured to execute either first backlight control or second backlight control, or it may be configured to select the control to execute according to the usage time of the liquid crystal display 10, etc.

The first backlight control and second backlight control will now be described. The example described here will be one in which the liquid crystal panel 20 is a normally black panel.

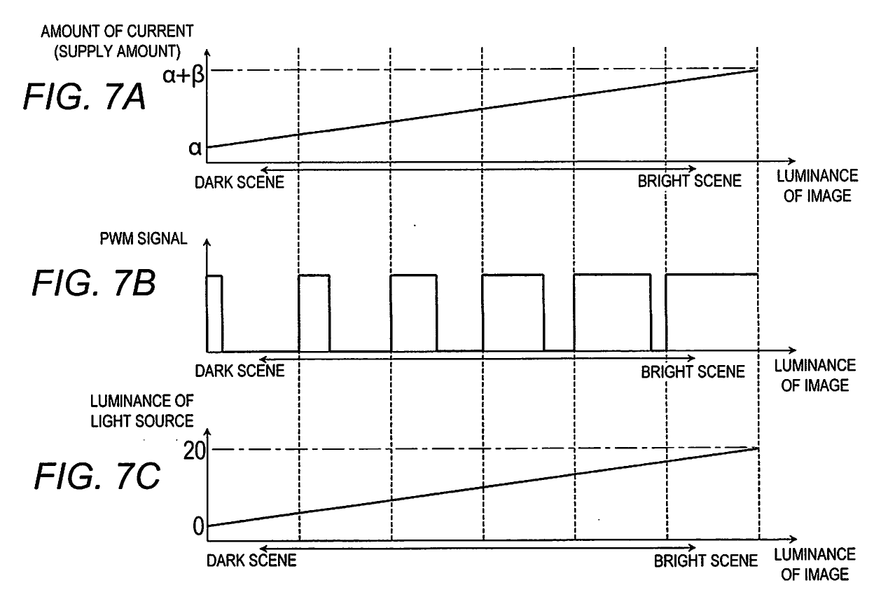

FIGS. 7A, 7B, and 7C are graphs of the relation of the luminance of the backlight 17, the PWM signal, and the amount of current to the sum total of the gradation values included in the video signal (luminance of the image) in the first backlight control.

In the first backlight control (first mode), the controller 30 controls so that the luminance of the backlight 17 will be higher when the luminance of the image being displayed is higher.

The greater is the total of the gradation values of the video signal, that is, the higher is the luminance of the image, the greater is the voltage value of the output signal of the current measurement circuit 31A. Therefore, as shown in FIGS. 7A and 7B, the controller 30 produces a PWM signal so that the greater is the voltage value of the output signal of the current measurement circuit 31A, the greater is the ratio of the duration of the high level during one period. As shown in FIGS. 7B and 7C, the greater is the ratio of the duration of the high level during one period of the PWM signal, the longer is the duration for which the backlight 17 is illuminated. That is, the luminance of the backlight 17 will be higher. Conversely, the lower is the total value of the gradation values of the video signal, the lower is the voltage value of the output signal of the current measurement circuit 31A. This time, the ratio of the duration of the high level in one period of the PWM signal produced by the controller 30 will be lower, and the backlight 17 will be illuminated for a shorter duration. That is, the luminance of the backlight 17 will be lower.

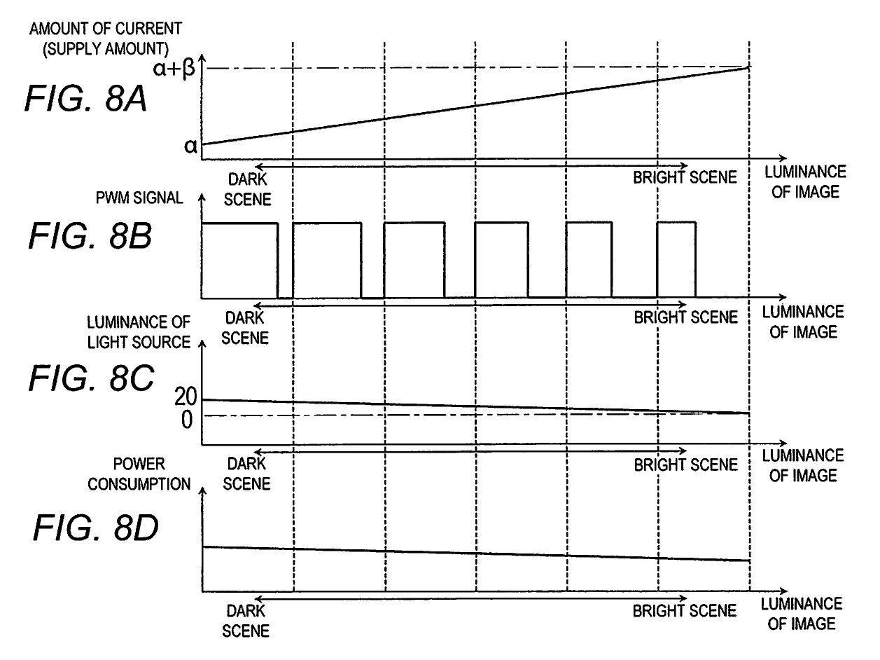

FIGS. 8A-8D are graphs of the relation of the luminance of the image to the PWM signal, the amount of current, and the luminance of the backlight 17 in the second backlight control. The graph in FIG. 8A is the same as the graph in FIG. 7A in order to compare the first backlight control with the second backlight control.

In the second backlight control (second mode), the controller 30 controls so that the luminance of the backlight 17 will be lower (FIG. 8C) when the luminance of the image being displayed is higher, so that the power consumption can be lowered (FIG. 8D) for the liquid crystal display as a whole. The proportional change in the duty ratio in the second backlight control (the amount of slope in the graph of light source luminance) is less than the proportional change in the duty ratio in the first backlight control shown in FIG. 1.

This configuration allows power consumption to be reduced for the liquid crystal display 10 as a whole when the image has high luminance.

In this embodiment, we described a case in which the controller 30 monotonically increased or decreased the duty ratio of a PWM signal, as in the first backlight control and second backlight control, but this is not the only option. The controller 30 may instead increase or decrease the duty ratio by some other method, such as increasing or decreasing the duty ratio as a square of the current amount, or increasing or decreasing it stepwise.

Specific Example of Duty Ratio and Amplitude of PWM Signal

The relation between the luminance of the light source (see the graph in FIGS. 7A-7C and 8C) and the duty ratio of the PWM signal (see the graph in FIGS. 7A-7C and 8B) shown in FIGS. 7A-7C and 8A-8D above will now be described in further detail.

In the above embodiment, the drive current supplied to the light source may be boosted. In view of this, we will describe three examples: in which the drive current is not boosted (example 1), and in which the drive current is boosted (examples 2 and 3). The extent to which the drive current is boosted is greater in example 3.

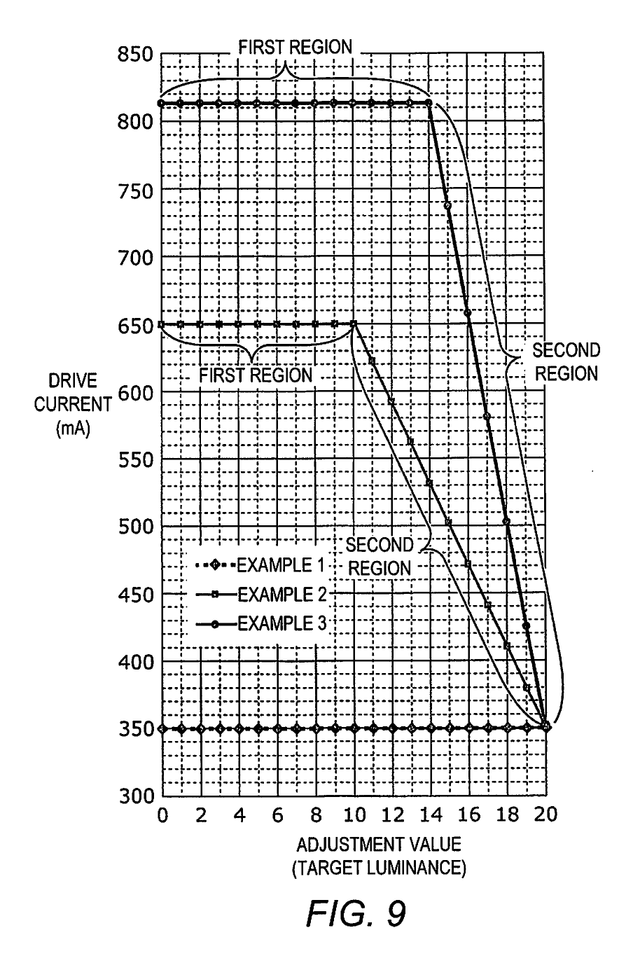

First, the relation between the amplitude of the drive current (corresponds to the current amount in the graphs in FIGS. 7A-7C and 8A) and the target luminance (corresponds to the luminance of the light source in the graphs in FIGS. 7A-7C and 8C) will be described through reference to FIG. 9.

FIG. 9 is a graph of examples 1 to 3, using the amplitude characteristics of drive current versus the target luminance (that is, the amount of drive current supplied during the period in which the backlight 17 is illuminated) as an example.

As shown in FIG. 9, in example 1 in which the drive current is not boosted, the amplitude of the drive current is a constant 350 mA regardless of the target luminance (one type of amplitude characteristic).

In contrast, in examples 2 and 3 in which the drive current is boosted, two amplitude characteristics are exhibited. In the case of examples 2 and 3, amplitude characteristics are exhibited which are different in a first region at or below a reference luminance, and a second region higher than the reference luminance.

More precisely, in example 2, in the first region at or under a reference luminance of 10, the change in the amplitude of the drive current versus the target luminance is zero. In the second region higher than a reference luminance of 10, the change in the amplitude of the drive current versus the target luminance is greater than zero. The plots of amplitude characteristics in the first and second regions are both indicated by a straight line. That is, the amplitude characteristics are the same within each region. The amplitude of the drive current in the first region is a fixed 650 mA regardless of the target luminance.

In example 3, in the first at or under a reference luminance of 14, the change in the amplitude of the drive current versus the target luminance is zero. In the second region higher than a reference luminance of 14, the change in the amplitude of the drive current versus the target luminance is greater than zero. The plots of amplitude characteristics in the first and second regions are both indicated by a straight line. The amplitude of the drive current in the first region is a fixed 815 mA regardless of the target luminance.

In both examples 2 and 3, the amplitude of the drive current varies continuously as the target luminance changes. The amplitude of the drive current decreases in inverse proportion to the target luminance in the second region. The amplitude of the drive current is the same 350 mA as in example 1 at the maximum value of the target luminance.

Thus, when the drive current is boosted, two different amplitude characteristics are exhibited in the region at or under the reference luminance and the region higher than the reference luminance. In the first region at or under the reference luminance, the change in the amplitude of the drive current is at or under a reference change. In the second region higher than the reference luminance, the change in the amplitude of the drive current is greater than the reference change.

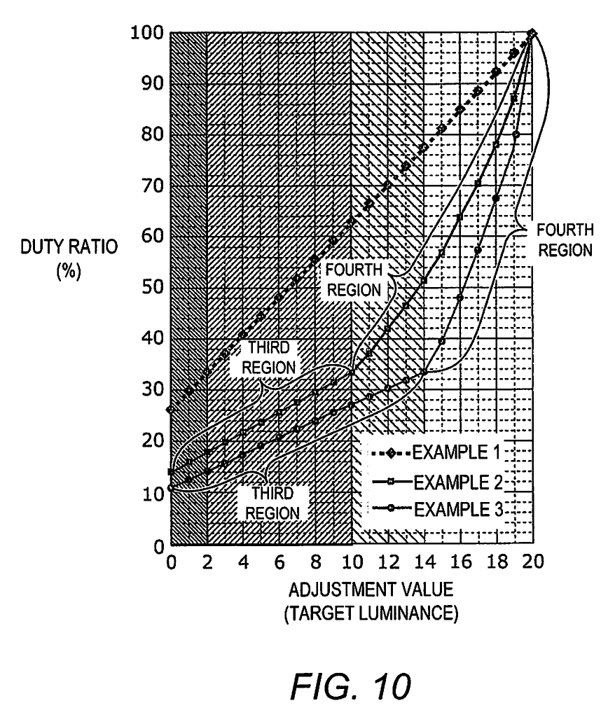

Next, the relation between the duty ratio of a PWM signal (corresponds to the graphs in FIGS. 7A-7C and 8B) and the target luminance (corresponds to the luminance of the light source in the graphs in FIGS. 7A-7C and 8C) will be described through reference to FIG. 10.

FIG. 10 is a graph of the above-mentioned examples 1 to 3, using the duty ratio characteristics of a drive signal (PWM signal) versus the target luminance (that is, the duty ratio of the backlight 17) as an example.

As shown in FIG. 10, in example 1 in which the drive current is not boosted, the duty ratio of the PWM signal varies at a constant slope versus the target luminance (one type of duty ratio characteristic).

In contrast, in examples 2 and 3 in which the drive current is boosted, two duty ratio characteristics are exhibited. In the case of examples 2 and 3, duty ratio characteristics are exhibited which are different in a third region at or below the reference luminance, and a fourth region higher than the reference luminance.

More precisely, in example 2, the change in duty ratio in a third region at or under a reference luminance of 10 is less than the change in duty ratio in a fourth region higher than a reference luminance of 10. In example 3, the change in duty ratio in the third region at or under a reference luminance of 14 is less than the change in duty ratio in the fourth region higher than a reference luminance of 14.

As shown in FIG. 9, in examples 2 and 3, because the drive current is boosted in the second region, the corresponding change in duty ratio in the fourth region is greater than the change in duty ratio in the third region.

Consequently, in examples 2 and 3 in which the drive current is boosted, a higher target luminance can be attained at a given duty ratio than in example 1 in which the drive current is not boosted (to put this the other way, a lower duty ratio can be attached at a given target luminance).

1-3. Effect, etc.

With the liquid crystal display 10 in this embodiment, the current measurement circuit 31A measures the amount of current flowing to the second power supply 42, so there is no need to compute the sum total of gradation values for a plurality of cells being written to. This reduces the load to which the controller 30 is subjected.

Also, with the liquid crystal display 10 in this embodiment, because the current measurement circuit 31A measures the amount of current flowing to the second power supply 42, computation of the total of gradation values can be carried out instantly. As discussed above, when computation of the total gradation value is merely switched over to a logic circuit, that is, when software control is merely replaced with hardware control, it will be difficult for the computation of the total gradation value to be carried out instantly, just as in conventional backlight control.

Also, in this embodiment, the duty ratio of the PWM signal varies according to the write processing for each row. That is, the luminance of the backlight 17 corresponds to the brightness of those pixels in each row. However, the human eye cannot tell the difference in brightness for each row, and the brightness for one frame is seen as an average. Therefore, what the human eye sees is substantially the same brightness as when backlight control is performed using a PWM signal having a duty ratio corresponding to the gradation values for one frame.

Also, in this embodiment, the current measurement circuit 31A is configured to measure the current flowing in one direction. With the liquid crystal display 10, inverse drive is generally performed in which the polarity of the voltage applied to the liquid crystals is inverted at regular intervals. Accordingly, a circuit that detects current in the opposite direction may be provided to measure the amount of current during inverse drive. This circuit that detects current in the opposite direction includes a transistor in which the base terminal is connected to the node N1, and the emitter terminal is connected to the node N2. In this case, the base terminal is an example of a control terminal, and the collector terminal and emitter terminal are examples of a first output terminal and a second output terminal.

Furthermore, with the liquid crystal display 10, the polarity of the voltage applied to the liquid crystals is inverted, for example, by setting the voltage value of the common voltage VCOM to different values during normal operation and during inverse operation, but the configuration may instead be such that the signals outputted from the source driver 22 all have positive polarity. In this case, there is no need to provide a circuit for detecting current in the opposite direction. Furthermore, in this case the configuration is such that the duty ratio of the PWM signal and the voltage of the signal inputted to the controller 30 are different during normal operation from those during inverse operation.

As mentioned above, in this embodiment, the liquid crystal display 10 (e.g., the display device) comprises the open cell 13 (e.g., the display), the backlight 17 (e.g., the light source) configured to emit light from the rear face side of the open cell 13, the power supply board 40 (e.g., the power supply) configured to supply power to the open cell 13, and the controller 30 configured to control the backlight 17 based on the supply amount (e.g., the value) of voltage and/or current supplied to the open cell 13. Here, the phrase “the supply amount of voltage and/or current” means “the supply amount of both voltage and current,” “the supply amount of voltage,” or “the supply amount of current.”

With the liquid crystal device 10, the open cell 13 includes the liquid crystal panel 20 (e.g., the display panel), and the source driver 22 (e.g., the driver) configured to supply the drive signal (e.g., the data signal) to the liquid crystal panel 20. The second power supply 42 of the power supply board 40 is further configured to supply voltage and/or current supplied to the source driver 22.

With the liquid crystal device 10, the power supply board 40 includes the first power supply 41 that is configured to convert AC power into first DC power PS1, and the second power supply 42 that is configured to convert the first DC power PS1 into the second DC power PS2 to supply the second DC power PS2 to the source driver 22. The supply amount is a supply amount of voltage and/or current of the first DC power PS1 and/or the second DC power PS2.

With the liquid crystal device 10, the controller 30 is configured to change the duty ratio of the PWM signal (e.g., the signal) for driving the backlight 17 based on the supply amount.

With the liquid crystal device 10, the controller 30 is configured to selectively execute the first backlight control (e.g., the first mode) in which the duty ratio is increased when the supply amount increases, and the second backlight control (e.g., the second mode) in which the duty ratio is reduced when the supply amount increases.

With the liquid crystal device 10, the controller 30 is configured to change the amplitude of the PWM signal or drive current (e.g., the signal) for driving the backlight 17 based on the supply amount.

With the liquid crystal device 10, the controller 30 is configured to change the luminance of the backlight 17 based on the supply amount.

With the liquid crystal device 10, the controller 30 is configured to control the backlight 17 based on the supply amount when the image is displayed on the liquid crystal panel 20 of the open cell 13.

The liquid crystal device 10 further comprises the current measurement circuit 31A (e.g., the detection component) configured to detect the supply amount of voltage and/or current supplied from the power supply board 40 to the open cell 13. The controller 30 is configured to control the backlight 17 based on detection result of the current measurement circuit 31A.

The liquid crystal device 10 further comprises the first resistor element RI inserted into the power supply line between the second power supply 42 of the power supply board 40 and the open cell 13. The controller 30 is configured to control the backlight 17 based on voltage across the first resistor element R1.

With the liquid crystal device 10, the supply amount is an amount of energy supplied during a predetermined period. The controller 30 is configured to control the backlight based on electric energy according to the supply amount (e.g., the value) of voltage and/or current supplied to the open cell 13.

Generally, the energy or electric energy is temporal integration of electric power. Thus, W=P×t=V×I×t, where W is electric energy, P is electric power, t is predetermined period, V is voltage, and I is current. In the illustrated embodiment, as mentioned above, the electric power is supplied from the second power supply 42 to the source driver 22 for a write processing row by row. Thus, the supply amount is an amount of energy supplied to a single row of the sub-pixels during a single write processing. Thus, in the illustrated embodiment, the time period for a single write processing for a single row is an example of the predetermined period. Of course, the predetermined period can be different from this time period. For example, as described later in the first modification example, the supply amount can be an amount of energy supplied for an entire sub-pixels of the liquid crystal panel 20. In other words, in this case, the time period for a plurality of write processings for an entire sub-pixels (or for a whole frame) of the liquid crystal panel 20.

With the liquid crystal device 10, the controller 30 is configured to increase the duty ratio when the supply amount increases.

Specifically, as illustrated in FIGS. 7A and 7B, the duty ratio of the PWM signal (FIG. 7B) increases as the supply amount of current (FIG. 7A) increases. Also, as understood from FIGS. 7A and 7C, the supply amount of current positively corresponds or correlated to the luminance of backlight 17, which corresponds to the adjustment value (the target luminance) illustrated in FIGS. 9 and 10. For example, as the supply amount of current increases from α (e.g., y-intercept of the graph in FIG. 7A) to α+β, the luminance of backlight 17 or the adjustment value (target luminance) increases from 0 to 20 (FIG. 7C). Of course, these values are merely an example, and can be different values, as desired or needed. Thus, in the illustrated embodiment, in the first backlight control (first mode), the adjustment value increases while the supply amount increases. On the other hand, as illustrated in FIGS. 8A and 8B, the duty ratio of the PWM signal (FIG. 8B) decreases as the supply amount of current (FIG. 8A) increases. Also, as understood from FIGS. 8A and 8C, the supply amount of current corresponds to the luminance of backlight 17, which corresponds to the adjustment value (the target luminance) illustrated in FIGS. 9 and 10. Thus, in the illustrated embodiment, in the second backlight control (second mode), the adjustment value increases while the supply amount decreases.

With the liquid crystal device 10, the controller 30 is configured to reduce the duty ratio when the supply amount decreases.

In the first backlight control (first mode), as illustrated in FIGS. 7A and 7B, the duty ratio of the PWM signal (FIG. 7B) decreases as the supply amount of current (FIG. 7A) decreases.

With the liquid crystal device 10, the controller 30 is configured to limit the amplitude of the PWM signal or drive current within a predetermined amplitude range when the supply amount changes within a supply amount range that is less than a predetermined supply amount.

Specifically, in the first backlight control (first mode), as illustrated in FIGS. 7A and 7B, the duty ratio of the PWM signal (FIG. 7B) increases as the supply amount of current (FIG. 7A) increases. Also, as understood from FIGS. 7A and 7C, the supply amount of current corresponds to the luminance of backlight 17, which corresponds to the adjustment value (the target luminance) illustrated in FIGS. 9 and 10. Furthermore, referring to FIG. 9, the amplitude of the drive current is a constant 650 mA in the first region for example 2 (or a constant 815 mA in the first region for example 3) when the adjustment value (the target luminance) changes within a range that is less than the target luminance of 10 (or less than the target luminance of 14). Therefore, as understood from FIGS. 7A-7C and 9, the amplitude of the PWM signal or drive current is limited within a predetermined amplitude range, which is a constant amplitude in the first region as shown in FIG. 9, when the supply amount of current changes within a supply amount range that is less than a predetermined supply amount that corresponds to the target luminance of 10 for example 2 (or target luminance of 14 for example 3). Furthermore, referring to FIG. 9, as mentioned above, the amplitude of the drive current is a constant 650 mA in the first region for example 2 that corresponds to the adjustment value (the target value) between 0 and 10 (or a constant 815 mA in the first region for example 3 that corresponds to the adjustment value (the target value) between 0 and 14). However, the amplitude of the drive current can be increased or decreased within a predetermined amplitude range, such as a range between 640 mA and 660 mA, for the first region of the adjustment value between 0 and 10. For example, the amplitude of the drive current can be decreased from 660 mA to 650 mA as the adjustment value increases from 0 to 10 in the first region of the adjustment value. In this case, the amplitude of the PWM signal or drive current is limited within the predetermined amplitude range (e.g., between 650 mA and 660 mA) when the supply amount of current changes within a supply amount range that is less than a predetermined supply amount that corresponds to the target luminance of 10 for example 2. More specifically, the supply amount range in this case corresponds to the first region of the adjustment value between 0 and 10 for example 2.

With the liquid crystal device 10, the controller 30 is configured to reduce the amplitude of the PWM or drive current when the supply amount increases within a supply amount range that is more than a predetermined supply amount.

Specifically, in the first backlight control (first mode), as illustrated in FIGS. 7A and 7B, the duty ratio of the PWM signal (FIG. 7B) increases as the supply amount of current (FIG. 7A) increases. Also, as understood from FIGS. 7A and 7C, the supply amount of current corresponds to the luminance of backlight 17, which corresponds to the adjustment value (the target luminance) illustrated in FIGS. 9 and 10. Furthermore, referring to FIG. 9, the amplitude of the drive current decreases in the second region for examples 2 and 3 when the adjustment value (the target luminance) increases within a range that is more than the target luminance of 10 for example 2 and the target luminance of 14 for example 3. Therefore, as understood from FIGS. 7A-7C and 9, in the first backlight control (first mode), the amplitude of the PWM signal or drive current is reduced in the second region as shown in FIG. 9 when the supply amount of current increases within a supply amount range that is more than a predetermined supply amount that corresponds to the target luminance of 10 for example 2 (or target luminance of 14 for example 3). More specifically, the supply amount range in this case corresponds to the second region of the adjustment value between 10 and 20 for example 2 (or between 14 and 20 for example 3).

With the liquid crystal device 10, the controller 30 is configured to increase the luminance when the supply amount increases.

Specifically, in the first backlight control (first mode), as illustrated in FIGS. 7A, 7B and 7C, the duty ratio of the PWM signal and the luminance of backlight 17 increases as the supply amount of current (FIG. 7A) increases.

With the liquid crystal device 10, the controller 30 is configured to decrease the luminance when the supply amount decreases.

Specifically, in the first backlight control (first mode), as illustrated in FIGS. 7A, 7B and 7C, the duty ratio of the PWM signal and the luminance of backlight 17 decreases as the supply amount of current (FIG. 7A) decreases.

With the liquid crystal device 10, the controller 30 is configured to reduce the duty ratio when the supply amount increases.

In the second backlight control (second mode), as illustrated in FIGS. 8A and 8B, the duty ratio of the PWM signal (FIG. 8B) decreases as the supply amount of current (FIG. 8A) increases.

With the liquid crystal device 10, the controller 30 is configured to increase the amplitude of the PWM signal or drive current when the supply amount increases within a supply amount range that is less than a predetermined supply amount.

Specifically, in the second backlight control (second mode), as illustrated in FIGS. 8A and 8B, the duty ratio of the PWM signal (FIG. 8B) decreases as the supply amount of current (FIG. 8A) increases. Also, as understood from FIGS. 8A and 8C, the supply amount of current negatively corresponds or correlated to the luminance of backlight 17, which corresponds to the adjustment value (the target luminance) illustrated in FIGS. 9 and 10. For example, as the supply amount of current increases from α (e.g., y-intercept of the graph in FIG. 8A) to α+β, the luminance of backlight 17 or the adjustment value (target luminance) decreases from 20 to 0 (FIG. 8C). Of course, these values are merely an example, and can be different values, as desired or needed. Furthermore, referring to FIG. 9, the amplitude of the drive current decreases in the second region for examples 2 and 3 when the adjustment value (the target luminance) increases within a range that is more than the target luminance of 10 for example 2 and the target luminance of 14 for example 3. Therefore, as understood from FIGS. 8A-8D and 9, in the second backlight control (second mode), the amplitude of the PWM signal or drive current is increased in the second region as shown in FIG. 9 when the supply amount of current increases within a supply amount range that is less than a predetermined supply amount that corresponds to the target luminance of 10 for example 2 (or target luminance of 14 for example 3). For example, the amplitude of the PWM signal or drive current is increased in the second region as shown in FIG. 9 when the supply amount of current increases from a, which corresponds to the target luminance of 20 for examples 2 and 3, to the predetermined supply amount, which corresponds to the target luminance of 10 for example 2 (or target luminance of 14 for example 3). More specifically, the supply amount range in this case corresponds to the second region of the adjustment value between 20 and 10 for example 2 (or between 20 and 14 for example 3).

With the liquid crystal device 10, the controller 30 is configured to limit the amplitude of the PWM signal or drive current within a predetermined amplitude range when the supply amount changes within a supply amount range that is more than a predetermined supply amount.

Specifically, in the second backlight control (second mode), as illustrated in FIGS. 8A and 8B, the duty ratio of the PWM signal (FIG. 8B) decreases as the supply amount of current (FIG. 8A) increases. Also, as understood from FIGS. 8A and 8C, the supply amount of current negatively corresponds or correlated to the luminance of backlight 17, which corresponds to the adjustment value (the target luminance) illustrated in FIGS. 9 and 10. Furthermore, referring to FIG. 9, the amplitude of the drive current is a constant 650 mA in the first region for example 2 (or a constant 815 mA in the first region for example 3) when the adjustment value (the target luminance) changes within a range that is less than the target luminance of 10 (or less than the target luminance of 14). Therefore, as understood from FIGS. 8A-8D and 9, the amplitude of the PWM signal or drive current is limited within a predetermined amplitude range, which is a constant amplitude in the first region as shown in FIG. 9, when the supply amount of current changes within a supply amount range that is more than a predetermined supply amount that corresponds to the target luminance of 10 for example 2 (or target luminance of 14 for example 3). Furthermore, referring to FIG. 9, as mentioned above, the amplitude of the drive current is a constant 650 mA in the first region for example 2 that corresponds to the adjustment value (the target value) between 0 and 10 (or a constant 815 mA in the first region for example 3 that corresponds to the adjustment value (the target value) between 0 and 14). However, the amplitude of the drive current can be increased or decreased within a predetermined amplitude range, such as a range between 640 mA and 660 mA, for the first region of the adjustment value between 0 and 10. For example, the amplitude of the drive current can be decreased from 660 mA to 650 mA as the adjustment value increases from 0 to 10 in the first region of the adjustment value. In this case, the amplitude of the PWM signal or drive current is limited within the predetermined amplitude range (e.g., between 650 mA and 660 mA) when the supply amount of current changes within a supply amount range that is more than a predetermined supply amount that corresponds to the target luminance of 10 for example 2. More specifically, the supply amount range in this case corresponds to the first region of the adjustment value between 10 and 0 for example 2.

With the liquid crystal device 10, the controller 30 is configured to decrease the luminance when the supply amount increases.

Specifically, in the second backlight control (second mode), as illustrated in FIGS. 8A, 8B and 8C, the duty ratio of the PWM signal and the luminance of backlight 17 decreases as the supply amount of current (FIG. 8A) increases.

### FIRST MODIFICATION EXAMPLE 1

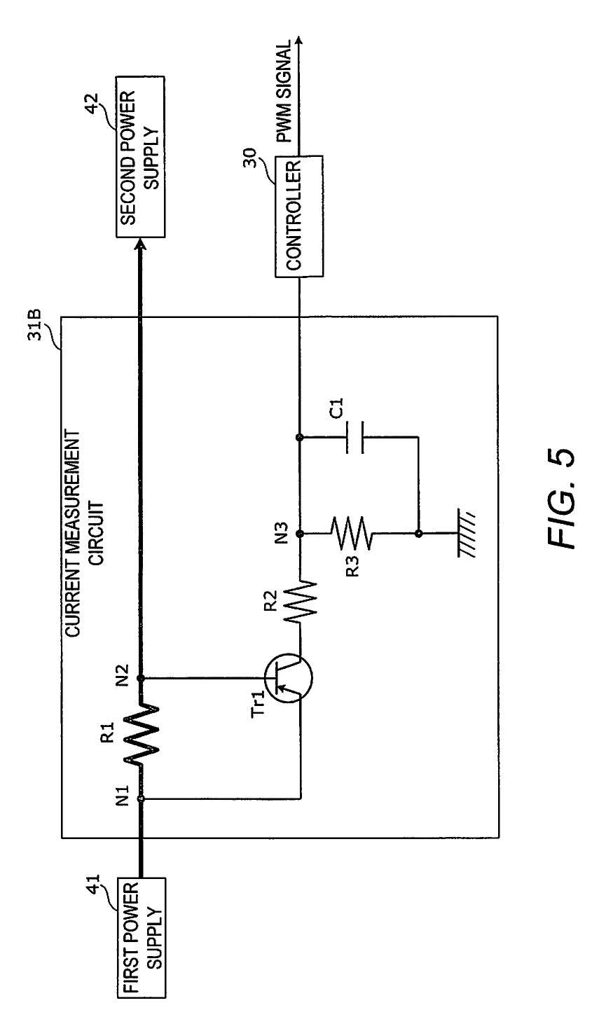

A first modification example of this embodiment will be described through reference to FIG. 5.

The liquid crystal display in this modification example differs from the liquid crystal display 10 in the embodiment in the circuit configuration of the current measurement circuit.

The liquid crystal display in this modification example includes a front cabinet 11, a bezel 12, an open cell 13, a cell guide 14, an optical member 15, a reflective member 16, a backlight 17, a rear frame 18, a power supply board 40, a current measurement circuit 31B, and a controller 30.

In this modification example, the configuration of everything but the current measurement circuit 31B, that is, the configuration of the front cabinet 11, the bezel 12, the open cell 13, the cell guide 14, the optical member 15, the reflective member 16, the backlight 17, the rear frame 18, the power supply board 40, and the controller 30, is the same as in the embodiment.

FIG. 5 is a diagram of an example of the configuration of the current measurement circuit 31B in this modification example.

The current measurement circuit 31B measures the amount of current flowing to the second power supply 42, and inputs the measurement result to the controller 30. As shown in FIG. 5, the current measurement circuit 31B includes a first resistor element a transistor Tr1, a second resistor element R2, a third resistor element R3, and a capacitor element C1.

The configuration of everything but the capacitor element C1 of the current measurement circuit 31B, that is, the configuration of the first resistor element R1, the transistor Tr1, the second resistor element R2, and the third resistor element R3, is the same as in the embodiment.

The capacitor element C1 is connected at one end to one end of the third resistor element R3, and at the other end to the other end of the third resistor element R3.

Providing the capacitor element C1 makes it possible to smooth out the voltage value of the output signal of the current measurement circuit 31B. That is, the voltage value of the output signal of the current measurement circuit 31B can be adjusted to match the total gradation value for one frame.

### SECOND MODIFICATION EXAMPLE

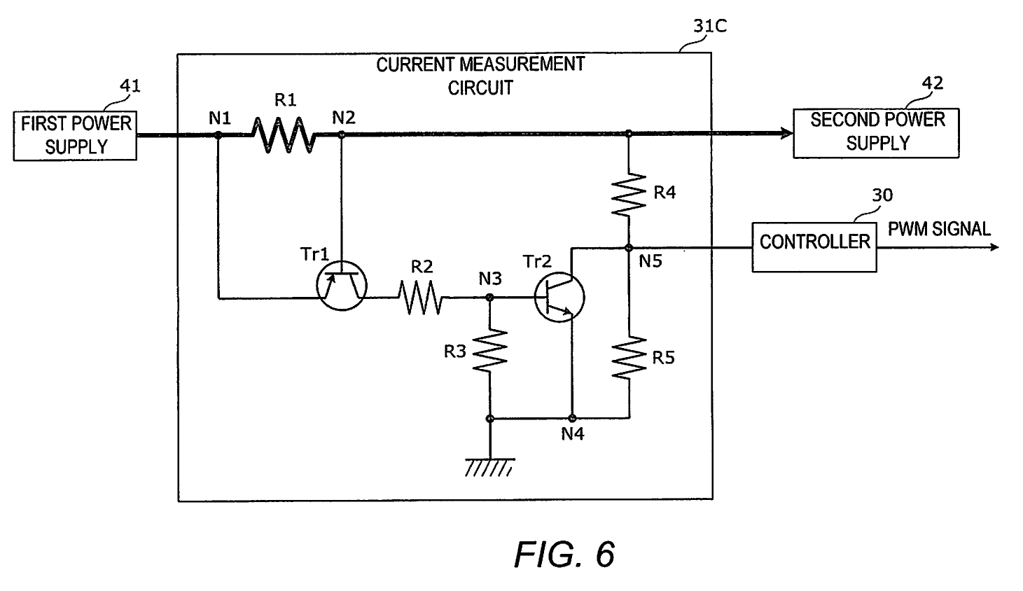

A second modification example of this embodiment will be described through reference to FIG. 6.

The liquid crystal display in this modification example differs from the liquid crystal displays in the embodiment and in the first modification example in the circuit configuration of the current measurement circuit.

The liquid crystal display in this modification example includes a front cabinet 11, a bezel 12, an open cell 13, a cell guide 14, an optical member 15, a reflective member 16, a backlight 17, a rear frame 18, a power supply board 40, a current measurement circuit 31C, and a controller 30.

In this modification example, the configuration of everything but the current measurement circuit 31C, that is, the configuration of the front cabinet 11, the bezel 12, the open cell 13, the cell guide 14, the optical member 15, the reflective member 16, the backlight 17, the rear frame 18, the power supply board 40, and the controller 30, is the same as in the embodiment.

FIG. 6 is a diagram of an example of the configuration of the current measurement circuit 31C in this modification example.

The current measurement circuit 31C measures the amount of current flowing to the second power supply 42, and inputs the measurement result to the controller 30. As shown in FIG. 6, the current measurement circuit 31C includes a first resistor element R1, a transistor Tr1, a second resistor element R2, a third resistor element R3, a transistor Tr2, a fourth resistor element R4, and a fifth resistor element R5.

The configuration of the first resistor element R1, the transistor Tr1, the second resistor element R2, and the third resistor element R3 is the same as in the embodiment.

The transistor Tr2 is connected at the base terminal to one end of the third resistor element R3 (the node N3), at the emitter terminal to the other end of the third resistor element R3 (a node N4), and at the collector terminal to a node N5, which the output node of the current measurement circuit 31C.

The fourth resistor element R4 is connected at one end to the node N2, and at the other end to the node N5.

The fifth resistor element R5 is connected at one end to the node N5, and at the other end to the node N4.

The transistor Tr2, fourth resistor element R4, and fifth resistor element R5 that are thus connected function as an inversion circuit that produces an inverse signal in which the signal of the node N3 is inverted.

Consequently, the liquid crystal display is compatible with being normal white, that is, when it is configured by sub-pixels in which the transmittance of the liquid crystals is greatest when no voltage is being applied, or is compatible with when the control of the backlight 17 is inverted. Inverting the control of the backlight 17 means that the luminance of the backlight 17 is reduced when the total gradation value is large, and the luminance of the backlight 17 is increased when the total gradation value is small.

### Other Embodiments

The display device pertaining to the embodiment of the present application is described above, but the present application is not limited to or by this embodiment.

(1) In the above embodiment and the first modification example, the liquid crystal panel 20 is a normally-black panel, and in first backlight control, the luminance of the backlight 17 is higher when the luminance of the image being displayed is higher. In this case, the larger is the inputted voltage value (supply amount), the larger is the duty ratio of the PWM signal produced by the controller 30, but this is not the only option.

When the liquid crystal panel 20 is a normally-white panel, and first backlight control is performed (when control is performed so that the luminance of the backlight 17 is higher when the luminance of the image being displayed is higher), then the larger is the inputted voltage value (supply amount), the smaller is the duty ratio of the PWM signal produced by the controller 30. With the normally-white liquid crystal panel 20, the transmittance of the liquid crystals is lowest when voltage is being applied.

Alternatively, when the liquid crystal panel 20 is a normally-black panel, and second backlight control is performed (when control is performed so that the luminance of the backlight 17 is lower when the luminance of the image being displayed is higher), then the larger is the inputted voltage value (supply amount), the smaller is the duty ratio of the PWM signal produced by the controller 30. When the liquid crystal panel 20 is a normally-white panel, and control is performed so that the luminance of the backlight 17 is -lower when the luminance of the image being displayed is higher, then the larger is the inputted voltage value (supply amount), the larger is the duty ratio of the PWM signal produced by the controller 30.

The above-mentioned first backlight control (first mode) of the controller 30 for the normally-black panel explained in the above embodiment can be used as a second backlight control (second mode) of a controller for a normally-white panel. Specifically, the relationships between the supply amount, the duty ratio of the PWM signal, the luminance of the backlight, and the adjustment value (target luminance) explained referring to FIGS. 7, 9 and 10 for the above-mentioned first backlight control (first mode) of the controller 30 for the normally-black panel can be applied to the relationships between the supply amount, the duty ratio of the PWM signal, the luminance of the backlight, and the adjustment value (target luminance) for a second backlight control (second mode) of a controller for the normally-white panel. Similarly, the above-mentioned second backlight control (second mode) of the controller 30 for the normally-black panel explained in the above embodiment can be used as a first backlight control (first mode) of a controller for a normally-white panel. Specifically, the relationships between the supply amount, the duty ratio of the PWM signal, the luminance of the backlight, and the adjustment value (target luminance) explained referring to FIGS. 8A-8D, 9 and 10 for the above-mentioned second backlight control (second mode) of the controller 30 for the normally-black panel can be applied to the relationships between the supply amount, the duty ratio of the PWM signal, the luminance of the backlight, and the adjustment value (target luminance) for a first backlight control (first mode) of a controller for the normally-white panel. Since these application can be apparent to the skilled in the art, the detailed explanation will be omitted for the sake of brevity.

In the second modification example, the output signal of the current measurement circuit 31C is an inverse signal in which the theoretical value is inverted from that in the embodiment or the first modification example, so the relation between the voltage value and the duty ratio is inverted.

(2) In the above embodiment and the first and second modification examples, an example is described in which a PWM signal is used to control the backlight 17, but the configuration may instead be such that a PWM signal is used to adjust the sharpness or contrast.

(3) In the above embodiment and the first and second modification examples, the current measurement circuits 31A and 31B sense the voltage difference of the first resistor element R1 by using the transistor Tr1, but the configuration may instead be such that the voltage difference of the first resistor element R1 is sensed by using an operational amplifier or other such circuit.

(4) A resistor element, a diode, or any other desired circuit elements may be added to the current measurement circuits 31A to 31C in the above embodiment and the first and second modification examples.

(5) In the above embodiment and the first and second modification examples, an example is described in which the liquid crystal display 10 operates under AC power inputted from the AC power supply 50, but this is not the only option. The liquid crystal display 10 may be configured such that it is operated by DC power inputted from a storage battery, such as in a portable television set. In this case, the first power supply 41 may be a DC/DC conversion circuit that converts the voltage value of DC power from a battery into another voltage value, rather than an AC/DC conversion circuit that converts AC power into DC power. Alternatively, the liquid crystal display 10 may not be equipped with the first power supply 41.

(6) Furthermore, the above embodiment and the first and second modification examples may be combined with each other.

The display device configured as above is useful as a display device equipped with a backlight, such as a liquid crystal display.

In view of the state of the known technology, a display device in accordance with an aspect of the present application includes a display panel (e.g., liquid crystal panel 20), a light source (e.g., backlight 17) that emits light from the rear face side of the display panel, a power supply (e.g., first and second power supplies 41 and 42) that supplies power to the display panel, a measurement component that measures a supply amount of Voltage and/or current supplied from the power supply to the display panel, and a controller (e.g., controller 30) that controls the light source according to the supply amount measured by the measurement component.

When the luminance of a backlight (the light source) is adjusted in a display device, the total of all the gradation values for the video signal is generally used. Therefore, the controller of a conventional display device has to compute the total gradation value for the video signal, which is a problem in that it imposes a heavy load on the controller.

The inventors turned their attention to the fact that the current amount of current flowing to the power supply that supplies electrical power to the display panel corresponds to the total gradation value for a plurality of cells (such as one line of cells). With a display device configured as above, a measurement component is used to measure the supply amount of power and/or current supplied from the power supply, such as the current amount of current flowing to the power supply or the voltage of the power supply, so there is no need for the controller to compute the total gradation value for a plurality of cells. With this configuration, the computation load on the controller can be decreased.

Also, with a display device configured as above, since the supply amount of the power supply is measured using a measurement component, the total gradation value for the cells can be found in real time. Furthermore, processing will be faster than computation by the controller even when computation of the total gradation value for a plurality of cells is merely switched over to a logic circuit, that is, when software control is merely replaced with hardware control. However, because a video signal has generally undergone compression coding, decoding and the like take time, which makes processing in real time difficult. Also, the need arises to adjust the timing at which the total gradation value is computed and the timing at which the light source is controlled. By contrast, with a display device having the above configuration, since the supply amount of the power supply is measured using a measurement component, control of the light source can be easily performed at the point when voltage is actually applied to the pixels.

For example, the display device may further includes a source driver that supplies a data signal to the display panel, wherein the power supply supplies power and/or current to the source driver, and the measurement component measures the supply amount of power and/or current supplied to the source driver.

Since the total gradation value corresponds to the supply amount of power supplied to the source driver, the supply amount that corresponds to the total gradation value can be found while reducing the processing load on the controller, by measuring the supply amount of power supplied to the source driver.

The display device may also be such that the power supply includes a first power supply for converting the AC power supplied from an AC power supply into first DC power, and a second power supply for converting the first DC power into second DC power and supplying it to the source driver, and the measurement component measures the supply amount of the first DC power and/or the second DC power.

The power at the power supply having a supply amount corresponding to the total gradation value can, for example, be either a first DC power that is supplied to a second power supply, or a second DC power that is supplied from the second power supply to the display panel side. Therefore, if the measurement component is configured to measure the first DC power supplied to the second power supply or the second DC power, then the total gradation value can be found while reducing the processing load on the controller.

Also, the controller may control the illumination period of the light source by producing a signal having a duty ratio corresponding to the measurement result of the measurement component. Also, the controller may selectively execute a first mode in which the duty ratio of the signal is increased when the supply amount has increased, and a second mode in which the duty ratio of the signal is reduced when the supply amount has increased.

With a display device configured as above, a PWM (pulse width modulation) signal is produced that has a duty ratio corresponding to the output signal from the measurement component, so the backlight can be properly controlled.

Also, the controller may control the luminance of the light source according to the supply amount measured by the measurement component.

With a display device configured as above, since the controller controls the luminance of the light source according to the supply amount, the processing load imposed on the controller in controlling the light source can be reduced.

Also, the controller may control the light source according to the supply amount when an image is being displayed on the display panel.

This allows the timing to be matched in the control of the light source and the measurement of the supply amount at the controller.

Also, the measurement component may have a first resistor element that is inserted into a power supply line connected to the input terminal of the power supply, or is inserted into a power supply line connected to the output terminal of the power supply, a switch element in which a control terminal is connected to one end of the first resistor element, and a first output terminal to the other end of the first resistor element, and which sends current, in an amount according to the voltage of the control terminal, in between the first output terminal and a second output terminal, and a second resistor element that is connected at one end to the second output terminal of the switch element.

With a display device configured as above, the measurement component can have a simple configuration. That is, the circuit can be simplified, so the circuit scale can be kept from increasing, and manufacturing costs can be kept lower. Furthermore, a display device having the above configuration can compute these average values faster.

With the display device pertaining to the present application, the load on the controller is reduced, and the backlight can be controlled more accurately.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only a selected embodiment has been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device comprising:
a display;
a light source that emits light from a rear face side of the display;
a power supply that supplies power to the display; and
a controller that controls the light source based on a value of voltage and/or current supplied to the display.

2. The display device according to claim 1, wherein
the display includes a display panel, and a driver that supplies a data signal to the display panel,
the power supply further supplies voltage and/or current to the driver.

3. The display device according to claim 1, wherein
the controller changes a duty ratio of a signal for driving the light source based on the value.

4. The display device according to claim 3, wherein
the controller selectively executes a first mode in which the duty ratio is increased when the value increases, and a second mode in which the duty ratio is reduced when the value increases.

5. The display device according to claim 1, wherein
the controller changes an amplitude of a signal for driving the light source based on the value.

6. The display device according to claim 1, wherein
the controller changes luminance of the light source based on the value.

7. The display device according to claim 1, wherein
the controller controls the light source based on the value when an image is displayed on the display.

8. The display device according to claim 1, further comprising
a detection component that detects the value of voltage and/or current supplied from the power supply to the display,
the controller controlling the light source based on detection result of the detection component.

9. The display device according to claim 1, further comprising
a first resistor element inserted into a power supply line between the power supply and the display,
the controller controlling the light source based on voltage across the first resistor element.

10. The display device according to claim 1, wherein
the controller controls the light source based on electric energy according to the value of voltage and/or current supplied to the display.

11. The display device according to claim 3, wherein
the controller increases the duty ratio when the value increases.

12. The display device according to claim 3, wherein
the controller reduces the duty ratio when the value decreases.

13. The display device according to claim 5, wherein
the controller limits the amplitude within a predetermined amplitude range when the value changes within a value range that is less than a predetermined value.

14. The display device according to claim 5, wherein
the controller reduces the amplitude when the value increases within a value range that is more than a predetermined value.

15. The display device according to claim 6, wherein
the controller increases the luminance when the value increases.

16. The display device according to claim 6, wherein
the controller decreases the luminance when the value decreases.

17. The display device according to claim 3, wherein
the controller reduces the duty ratio when the value increases.

18. The display device according to claim 5, wherein
the controller increases the amplitude when the value increases within a value range that is less than a predetermined value.

19. The display device according to claim 5, wherein
the controller limits the amplitude within a predetermined amplitude range when the value changes within a value range that is more than a predetermined value.

20. The display device according to claim 6, wherein
the controller decreases the luminance when the value increases.
